(19) United States
(12) Patent Application Publication
(10) Pub. No.: US 2005/0045203 A1
(43) Pub. Date: Mar. 3, 2005

(54) Removing carpet depressions

(76) Inventor: Donald V. Edwards, Harrison City, PA (US)

Correspondence Address: JAMES RAY & ASSOCIATES, 2640 PITCAIRN ROAD, MONROEVILLE, PA, 15146, US

(21) Appl. No.: 10/875,886

(22) Filed: Jun. 24, 2004

Related U.S. Application Data
(63) Continuation-in-part of application No. 10/647,198, filed on Aug. 25, 2003, now abandoned.

(51) Int. Cl. B08B 7/00; A47L 13/50

(52) U.S. Cl. 134/6; 15/257.01; 15/1; 81/488

(57) ABSTRACT

A tool for assisting in removing at least one depression located in a carpet. The tool comprises a first member having a predetermined length and a predetermined shape and a point formed on a first end of the first member for penetrating such carpet closely adjacent such depression. There is a handle member disposed on the first member adjacent a second end thereof for assisting in manipulation of the point to a location disposed near and beneath a center of such depression and at least one bend, having a predetermined angle, formed in the first member intermediate the first end and the second end of the first member for angling the first end of the first member to a position which will assist in raising such carpet adjacent such depression to enable brushing the depression in such carpet thereby substantially eliminating such depression.

### CROSS-REFERENCE TO RELATED APPLICATIONS

This application is a continuation-in-part of co-pending patent application Ser. No. 10/647,198, now abandoned.

### FIELD OF THE INVENTION

The present invention pertains to hand tools, and more particularly, the present invention pertains to a hand tool and a method for applying the hand tool for removing depressions in carpet fibers.

### BACKGROUND OF THE INVENTION

After furniture has been resting upon a carpeted surface for a considerable period of time and is thereafter moved, depressions or dimples remain in the carpet pile which are considered to be unsightly. In order to remove these depressions in the carpet fibers, one normally tries to raise the carpet fibers by working an implement, such as a card or spoon, or ones fingers, over the depressed carpet fibers. However, the results are insufficient and inadequate since evidence of the depression remain.

### SUMMARY OF THE INVENTION

The present invention provides a tool for assisting in removing at least one depression located in a carpet. The tool comprises a first member having a predetermined length and a predetermined shape and a point formed on a first end of the first member for penetrating such carpet closely adjacent such at least one depression. There is a handle member disposed on the first member adjacent a second end thereof for assisting in manipulation of the point to a location disposed near and beneath a center of such at least one depression and at least one bend, having a predetermined angle, formed in the first member intermediate the first end and the second end of the first member for angling the first end of the first member to a position which will assist in raising such carpet adjacent such at least one depression to enable brushing the at least one depression in such carpet thereby substantially eliminating such at least one depression.

Another embodiment of the invention provides a method of removing a depression area in fibers of a carpet. Such method comprises the steps of penetrating a pointed end of a bent stiff wire probe through the carpet adjacent the depression to be removed; manipulating the bent wire probe to position the pointed end under the depression; further manipulating the bent wire probe to raise the depressed area with the probe point; brushing the depressed carpet fibers in the depression while raised to raise the depressed fibers and removing the bent wire probe.

### OBJECTS OF THE INVENTION

It is one of the principal objects of the present invention to provide a tool which will assist in removing carpet depressions.

It is also an object of the present invention to provide a method for adequately removing the carpet depressions.

Another object of the present invention is provide a tool for removing carpet depressions which will inexpensive to manufacture.

In addition to the numerous objects and advantages of the present invention which have been described with some degree of particularity above, it should be both noted and understood that a number of other important objects and advantages of the invention will become more readily apparent to those persons who are skilled in the relevant art of furniture moving from the following more detailed description of the invention, particularly, when such detailed description is taken in conjunction with the appended claims.

### BRIEF DESCRIPTION OF THE DRAWINGS

FIG. 1 is a side elevation view of one embodiment of the tool of the present invention.

FIG. 2 is a top view of the tool shown in FIG. 1.

FIG. 3 is a side elevation view of another embodiment of the tool of the present invention.

FIG. 4 is a side elevation view, shown partially in vertical cross section, illustrating the use of the tool shown in FIGS. 1 and 2 in employing the method of the present invention for the removal of carpet fiber depressions.

### BRIEF DESCRIPTION OF THE PRESENTLY PREFERRED AND VARIOUS ALTERNATE EMBODIMENTS OF THE PRESENT INVENTION

Prior to proceeding to the more detailed description of the present invention, it should be noted that for the sake of clarity in understanding the invention, identical components with identical functions have been designated with identical reference numerals throughout the drawing Figures.

The present invention provides a tool, generally designated 10, for assisting in removing at least one depression located in a carpet. The tool 10 comprises a first member 11 (also referred to in the specification as a stiff wire shaft) having a predetermined length and a predetermined shape. There is a point 12 formed on a first end of the first member 11 for penetrating such carpet closely adjacent the depression.

A handle member 13 is disposed on the first member 11 adjacent a second end thereof for assisting in manipulation of the point 12 to a location disposed near and beneath a center of the depression in the carpet. Such first member 11 has at least one bend 15, which has a predetermined angle, formed in the first member 11 intermediate the first end and the second end of such first member 11 for angling the first end of the first member 11 to a position which will assist in raising such carpet adjacent such depression to enable brushing the depression in such carpet thereby substantially eliminating such depression.

In the presently preferred embodiment of the invention such first member 11 has two bends 14, 15 that are disposed intermediate the first end and the second end of the first member 20. Each of the bends 14, 15 have a predetermined angle. It is also preferred that such predetermined angle for each bend 14, 15 be approximately 30 degrees.

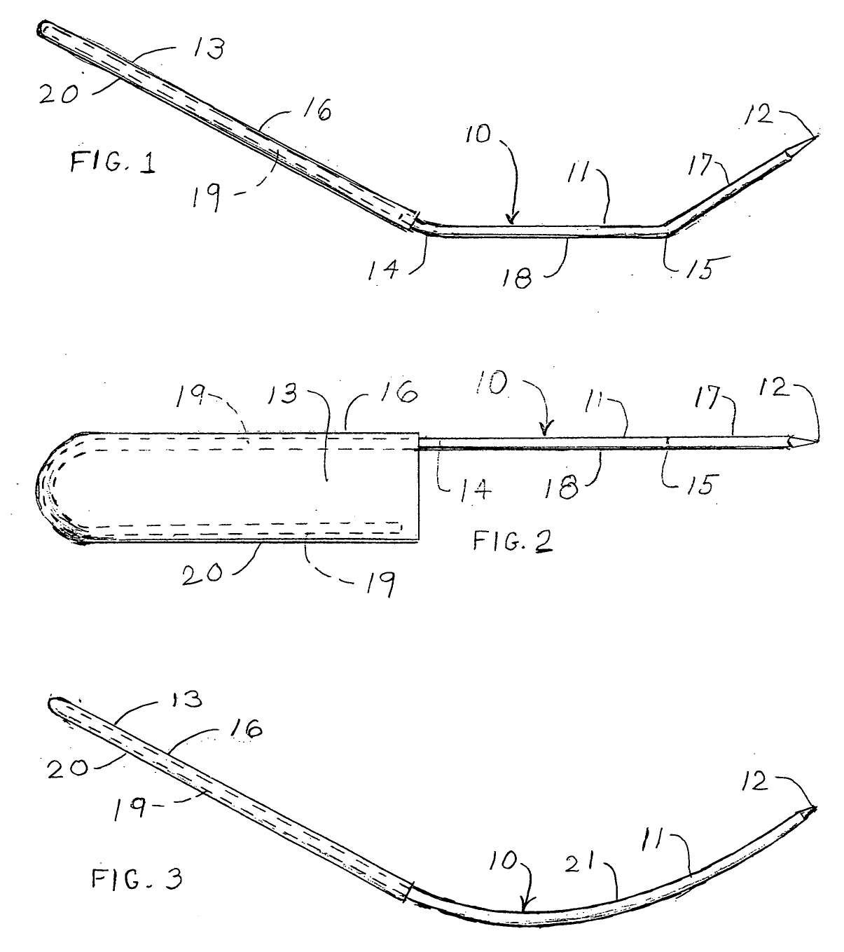

Referring to FIGS. 1 and 2, the tool of the present invention includes a fist member (stiff wire probe shaft) 11 having a point 12 at one end and a handle 13 at the other. end for manipulation of the tool. The wire probe shaft 11 is provided with at least one bend in a common vertical plane, and the tool 10 illustrated in the embodiment of FIG. 1 is provided with two bends 14 and 15. These two bends are in a common vertical plane. The tool of this embodiment has three segments separated by bends 14 and 15, comprised of an upturned proximal handle segment 16, an upturned distal pointed segment 17, and an intermediate horizontal segment 18. These bends are each approximately 30° and this shape of the tool permits proper manipulation of the tool to carry out the method of the present invention as discussed in more detail hereinafter. The handle 13 is comprised of a U-shaped bend 19 in the wire probe shaft 11 with a plastic sleeve snugly received thereover.

The embodiment of FIG. 3 serves the same function and purpose; however, only one continuous bend 21 is provided on the wire probe shaft 11, the bend being applied only in one single vertical plane.

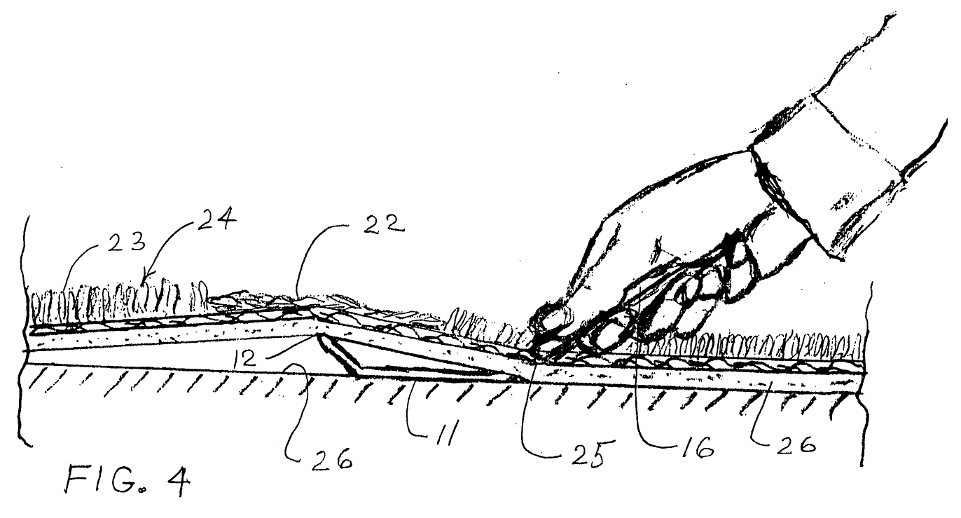

Referring now to FIG. 4, implementation of the tool 10 of the present invention is illustrated. This figure illustrates the method of the present invention for removing an indentation or depression area 22 of the carpet pile fibers 23 which had been left by a furniture leg previously rested on the carpet 24. The pointed end 12 of the wire probe shaft 11 is penetrated through the carpet 24 at a point 25 adjacent the depression 22 in the fibers 23 to be removed, and then penetration is continued on through the underlying foam carpet pad 26. The tool 10 is then manipulated with handle 16 to position the pointed end 12 of the probe shaft 11 under the depression 22. The bent wire probe shaft 11 is further manipulated against the floor surface 26 to raise the depressed area 22 of the carpet with the probe point 12 as illustrated in FIG. 4. While the carpet depression is in this raised position, then one brushes the depressed carpet fibers in the area of the depression 22 while raised as indicated to raise the depressed fibers therein. This brushing may be accomplished by using a spoon, a card or ones fingers. The bent wire probe shaft 11 is then removed and this procedure may be repeated as required by inserting the pointed end 12 of the probe 11 at different points adjacent the depression 22 and thereby repeating the procedure by raising different areas of depression 22 and scraping or brushing until the depressed area of fibers is completely removed.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

1. A tool for assisting in removing at least one depression located in a carpet, said tool comprising:
(a) a first member having a predetermined length and a predetermined shape;
(b) a point formed on a first end of said first member for penetrating such carpet closely adjacent such at least one depression;
(c) a handle member disposed on said first member adjacent a second end thereof for assisting in manipulation of said point to a location disposed near and beneath a center of such at least one depression; and
(d) at least one bend, having a predetermined angle, formed in said first member intermediate said first end and said second end of said first member for angling said first end of said first member to a position which will assist in raising such carpet adjacent such at least one depression to enable brushing said at least one depression in such carpet thereby substantially eliminating such at least one depression.

2. The tool, according to claim 1, wherein said first member has two bends in a common plane whereby said tool has three segments separated by said bends comprised of an upturned proximal handle segment, an upturned distal pointed segment and an intermediate horizontal segment.

3. The tool, according to claim 2, wherein said bends are approximately 30°.

4. The tool, according to claim 1, wherein said handle is comprised of a U-shaped bend in said first member with a plastic sleeve snugly received thereover.

5. The method of removing a depression area in fibers of a carpet comprising the steps of:
penetrating a pointed end of a bent wire probe through the carpet adjacent the depression to be removed;
manipulating the bent wire probe to position the pointed end under the depression;
further manipulating the bent wire probe to raise the depressed area with the probe point;
brushing the depressed carpet fibers in the depression while raised to raise the depressed fibers; and removing the bent wire probe.

6. The method, according to claim 5, wherein the step of penetrating includes also penetrating the underlying carpet.
